(19) United States
(12) Patent Application Publication
(10) Pub. No.: US 2016/0209179 A1
(43) Pub. Date: Jul. 21, 2016

(54) BALLISTIC RESISTANT ARTICLE AND METHOD OF PRODUCING SAME

(71) Applicant: UMM AL-QURA UNIVERSITY, Makkah (SA)

(72) Inventor: Hend Saleh Sulaiman Abdulghaffar, Taif (SA)

(73) Assignee: UMM AL-QURA UNIVERSITY, Makkah (SA)

(21) Appl. No.: 14/417,904

(22) PCT Filed: Jan. 21, 2015
(86) PCT No.: PCT/IB2015/000058

§ 371 Date: Jan. 28, 2015

(51) Int. Cl. F41H 5/04; B32B 5/02; B32B 37/14

(52) U.S. Cl. CPC F41H 5/0485; B32B 37/14; B32B 5/024; B32B 2571/02; B32B 2255/02; B32B 2262/02

(57) ABSTRACT

An article includes a first level of fabric, a second level of fabric, and a third level of fabric. The second level of fabric is disposed in between the first level of fabric and the third level of fabric, and at least one of the levels of fabric includes a plurality of layers. The plurality of layers are arranged such that fibers of one layer extend along a first direction and fibers of another layer extend along a second direction that is substantially diagonal to the first direction.

### FIELD OF THE INVENTION

The present application relates to a ballistic resistant article, and more particularly, to body armor that incorporates various types of fabric and arrangement configurations.

### BACKGROUND OF THE INVENTION

In recent years, researchers have concentrated on ways to reduce the weight of a vest or other protective wear and to protect torso from ballistics.

Conventionally, the vest should be capable of meeting two requirements. It should not be penetrated when struck by multiple ballistic rounds in a well-defined shot-pattern, and the back of the vest should not be deformed by more than 44 mm according to NIJ standard-0101.04.

To identify ways to reduce the weight of the vest, researchers have conducted interviews with organizations involved with body armor development and procurement, reviewed available literature on testing issues, and conducted independent analysis on future materials for soft and hard armor vests. The researches then compared four approaches to reducing the weight of vest-refining requirements, using modular configurations, improving testing, and improving materials. The following disclosures, which are incorporated herein by reference, provide some description regarding current technologies for body armor.

U.S. Pat. Nos. 3,971,072 and 3,988,780 relate to lightweight armor and method of fabrication of the same. Reinforced body armor and the like are fabricated by securing a thin ballistic metal outer shell to a plurality of layers of flexible material having qualities resistant to ballistic penetration. The layers of flexible material are sewn together along paths spaced within a selected predetermined range, so as to restrict movement of the fabric layers in lateral and longitudinal directions and to compact the layers in an elastic mass, thereby to provide resistance to penetration of the material by a ballistic missile and to reduce back target distortion.

U.S. Pat. No. 4,183,097 relates to a contoured, all-fabric, lightweight body armor garment for the protection of a woman against small arms missiles and spall which comprises a contoured front protective armor panel composed of a plurality of superposed layers of ballistically protective plies of fabric made of aramid polymer yarns, the front protective armor panel being contoured by providing overlapping seams joining two side sections to a central section of the panel so as to cause the front protective armor panel to be contoured to the curvature of the bust of a female.

U.S. Pat. No. 4,522,871 relates to a ballistic material comprising a multiplicity of plies of ballistic cloth woven with an aramid thread (e.g., Kevlar®), one or more of which are treated with resorcinol formaldehyde latex to coat the aramid threads and fill the interstices between the threads of a treated ply.

U.S. Pat. No. 4,510,200 relates to material useful in bulletproof clothing is formed from a number of laminates arranged one on top of another. The laminates are formed of a substrate coated with crushed thermo settable foam that, in turn, is covered with a surface film, which may be an acrylic polymer. The films should form the outermost layers of the composite material which together with the foam layer, in order to prevent degradation of the substrate, which is typically formed of fabric woven from Kevlar®.

U.S. Pat. No. 4,331,091 describes three-dimensional thick fibers made from a laminate of fabric plies held together by yarn-looped through holes in the structure.

U.S. Pat. No. 4,584,228 describes a bulletproof garment including several layers of textile fabric or foil superimposed on a shock absorber, in which the shock absorber is a three-dimensional fabric with waffle-like surfaces, a hollow part of at least 90% by volume and a thickness of 5 to 30 mm.

U.S. Pat. No. 4,916,000 describes a composite which comprises one or more layers, at least one of said layers comprising network of high strength filaments having a tensile modulus of at least about 160 grams/denier, a tenacity of at least about 7 g/denier and an energy-to-break of at least about 8 joules/gram in a matrix material. The ratio of the thickness of said layer to the equivalent diameter of said filaments is equal to or less than about 12.8, and complex composite articles formed from said composite.

U.S. Pat. No. 4,403,012 describes articles of vests which contain a network of ultrahigh molecular weight, high strength, high modulus polyethylene or polypropylene fibers. The fibers, and especially polyethylene fibers of 15, 20, 25, 30 or more g/denier tenacity, and 300, 500, 1000, 1500 or more g/denier tensile modulus impart ballistic resistance to the articles in spite of the melting points, e.g., 145° C.-151° C., for the polyethylene fibers and 168° C.-171° C. for the polypropylene fibers, which are high for these polymers, but substantially lower than the 200° C. or more melting point previously thought necessary for good ballistic resistance.

U.S. Pat. No. 4,681,792 relates to flexible articles of manufacture which include a plurality of first flexible layers arranged in a first portion of said article, each of said first layers consisting essentially of fibers, the fibers of each of said flat layers comprising fibers having a tensile modulus of at least about 300 g/denier and a tenacity of at least about 15 g/denier and a plurality of second flexible layers arranged in a second portion of said article, each of said second flexible layers comprising fibers, the resistance to displacement of fibers in each of said second flexible layers being greater than the resistance to displacement of fibers in each of said first flexible layers.

U.S. Pat. No. 4,501,856 describes a composite containing a network of ultra-high molecular weight polyethylene or polypropylene fibers of high tenacity and modulus and a matrix which has ethylene or propylene, e.g. polyethylene, polypropylene or copolymers. The composite can be formed by heating the matrix to its melting or sticking temperature around the fibers. The composite retains a high proportion of the tenacity of the fiber.

As discussed above, high-strength polymer fabrics may be used for protective systems due to their mechanical properties and impact resistance. For example, high-performance polymer fibers such as aramid fiber (aromatic polyimide), ultra-high molecular weight polyethylene (UHMWPE) fibers and Zylon poly (p-phenylene-2,6-benzobisoxazole) fibers have properties such as lightness, flexibility, high Young's modulus and impact resistance.

Fiber-reinforced polymer composites have been widely used for protective structures, particularly those with high-performance fibers. When fiber-reinforced polymers are intended to be used for lightweight ballistic protection or soft armor, weak fiber-matrix adhesion is required to allow the fibers maximum deformation, thus absorbing more impact energy.

Thermoplastic polymers may have an advantage over thermosetting matrices, which are known for their high stiffness and low deformation. It has been shown that by adding limited amounts of thermoplastic resin to the fabric, impact resistance can be obtained, because the thermoplastic matrix maintains the orientation and position of the fibers during an impact event, and distributes the load caused by the impact among the fibers. In laminate composites, the matrix may enable delamination and de-bonding, which may be energy-absorbing mechanisms. The matrix may also protect the fibers from environmental factors such as the reduction of impact resistance under conditions of high humidity and the reduction of mechanical properties due to photo-degradation caused by ultra-violet radiation.

One of the most well-known polymeric fibers for protective systems is aramid fiber with the commercial name Kevlar®. Fabrics made with this aramid fiber may have high strength, high modulus and good tenacity, which are desirable properties for ballistic applications. However, the fabrics are expensive and the design of protective equipment with these fabrics should include studies to reduce the amount of required fabric layers without compromising the effectiveness of the armor. The available experimental data in open literature for aramid/thermoplastic matrix composites is limited. Moreover, aramid/polypropylene systems have not been studied in detail, despite the fact that polypropylene (PP) is inexpensive and exhibits low adhesion to aramid fiber, which is desirable for soft armor.

The following additional disclosures also provide some description regarding body armor and are incorporated herein by reference.

(1) http://www.rand.org/capabilities/solutions/lightening-body-armor.html

(2) A. Tabiei, G. Nilakantan. Ballistic Impact of Dry Woven Fabric Composites: A Review. Appl. Mech. Rev 2008; 61(1):010801.

(3) A. Batnaghar, B. Arvidson: in: Lightweight ballistic composites, military and law enforcement applications. CRC Press. 2006. p. 272-304.

(4) B. A. Cheeseman, T. A. Bogetti. Ballistic impact into fabric and compliant composite laminates. Compos. Struct. 2003; 61(1-2):161.

(5) R. Zaera: in: Impact Engineering of Composite Structures. Springer Vienna. 2011. p. 305-403.

(6) H. H. Yang. Kevlar aramid fiber. John Wiley & Sons. 1993.

(7) C. H. Choi, Y. S. Ok, B. K. Kim, C. S. Ha, W. J. Cho, Y. J. Shin. Melt rheology and property of short aramid fiber reinforced polyethylene composites. J Korean Ind. Eng. Chem. 1992;3(1):81.

(8) N. K. Naik, P. Shrirao. Composite structures under ballistic impact. Compos. Struct. 2004;66(1-4):579.

(9) S. Bazhenov. Dissipation of energy by bulletproof aramid fabric. J Mater. Sci. 1997; 32(15):4167.

(10) M. G. Dobb, R. M. Robson, A. H. Roberts. The ultraviolet sensitivity of Kevlar 149 and Technora fibres. J Mater. Sci. 1993; 28(3):785.

(11) X. Liu, W. Yu, N. Pan. Evaluation of high performance fabric under light irradiation. J. Appl. Polym. Sci. 2011; 120(1):552.12.

(12) R. Park, J. Jang. Effect of laminate thickness on impact behavior of aramid fiber/vinylester composites. Polym. Test 2003; 22(8):939.

(13) R. H. Zee, C. Y. Hsieh. Energy loss partitioning during ballistic impact of polymer composites. Polym. Compos. 1993; 14(3):265.

(14) E. M. Petrie. Handbook of Adhesives and Sealants. McGraw-Hill. 2000.

(15) ASTM D5035. Standard Test Method for Breaking Force and elongation of Textile Fabrics (Strip Method)

(16) ASTM D3787. Standard Test Method for Bursting Strength of Textiles-Constant-Rate-of-Traverse (CRT) Ball Burst Test.

(17) Ballistic Resistance of Personal, Body Armor, NIJ Standard-0101.04.

(18) http://www2.dupont.com/Kevlar/en_US/assets/downloads/KEVLAR_Technical_Guide.pdf.

(19) http://www.honeywell.com/sites/servlet/com.merx.npoint.servlets.DocumentServlet?docid=D 19CB058F-D839-EA79-85BC-E26A581EAB36.

### SUMMARY OF THE INVENTION

According to one embodiment, an article may include a first level of fabric, a second level of fabric, and a third level of fabric, wherein the second level of fabric may be disposed in between the first level of fabric and the third level of fabric, and at least one of the levels of fabric may include a plurality of layers, the plurality of layers being arranged such that fibers of one layer extend along a first direction and fibers of another layer extend along a second direction that is substantially diagonal to the first direction.

According to another embodiment, the first level of fabric may include unidirectional (UD) aramid.

According to another embodiment, the second level of fabric may include ultra-high-molecular-weight polyethylene (UHMWPE).

According to another embodiment, the third level of fabric may include woven aramid.

According to another embodiment, the first level of fabric may include at least six layers of the UD aramid.

According to another embodiment, the second level of fabric may include at least twelve layers of the UHMWPE.

According to another embodiment, the third level of fabric may include at least eight layers of the woven aramid.

According to another embodiment, the first level of fabric includes only six layers of the UD aramid.

According to another embodiment, the second level of fabric includes only twelve layers of the UHMWPE.

According to another embodiment, the third level of fabric includes only eight layers of the woven aramid.

According to another embodiment, the plurality of layers may be arranged such that adjacent layers do not have fibers extending in a same direction.

According to another embodiment, the first level of fabric may be configured to absorb sudden energy of a projectile.

According to another embodiment, the second level of fabric may be configured to distribute and absorb energy of a projectile.

According to another embodiment, the third level of fabric may be configured to stop a projectile and to reduce blunt trauma.

According to another embodiment, the reduction of blunt trauma may be 17 mm.

According to another embodiment, the first level of fabric may be configured to receive a first impact from a projectile.

According to another embodiment, a combination of the first level of fabric, the second level of fabric, and the third level of fabric may have a maximum weight of approximately 2.9 kg according to NIJ Standard 0101.04.

According to another embodiment, the plurality of layers may be arranged in an alternating manner.

According to another embodiment, a method of manufacturing an article, comprising: forming a first level of fabric, forming a second level of fabric, forming a third level of fabric, arranging the second level of fabric in between the first level of fabric and the third level of fabric, and combining the first level of fabric, the second level of fabric, and the third level of fabric.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an exemplary breaking strength of UD aramid fabric.

FIG. 2 illustrates an exemplary breaking strength of UHMWPE.

FIG. 3 illustrates an exemplary breaking strength of Aramid Sheet.

FIG. 4 illustrates an exemplary bursting strength of UD aramid fabric.

FIG. 5 illustrates an exemplary bursting strength of UHMWPE.

FIG. 6 illustrates an exemplary bursting strength of Aramid Sheet.

FIG. 7 illustrates an arrangement of layers of an article according to one embodiment.

FIG. 8 illustrates a cross-sectional view of an article according to one example.

FIG. 9 is a flowchart showing a method for manufacturing an article according to one example.

### DETAILED DESCRIPTION

The present invention includes an impact resistant article which incorporates various types of impact resistant fabric and arrangement configurations.

According to an embodiment, the impact resistant article can be used as a bulletproof vest to help absorb and dissipate kinetic energy from a projectile and/or percussive energy from shockwaves. The bulletproof vest may include a substantially rectangular front body portion, a substantially rectangular back body portion, and a plurality of flaps that partially wrap around the sides of a user's torso. At least two of the flaps may be configured such that they are permanently attached (or detachable) to the ends of the substantially rectangular front body portion and substantially rectangular back body portion. Furthermore, it is noted that each of these two flaps may be disposed at a predetermined distance (e.g., 12 inches to 16 inches) from each other so as to allow a user to insert his/her head in between the two flaps when the user puts on the bulletproof vest. Moreover, the substantially rectangular front body portion and the substantially rectangular back body portion may each be approximately 16 inches wide and approximately 18 inches long, and each of the flaps may range from 2 inches to 4 inches wide and 6 inches to 12 inches long. However, it will be appreciated that the bulletproof vest is not limited to the dimensions recited above, and any other suitable dimensions may be selected based upon the size of the user.

According to another aspect, the bulletproof vest may be configured to conform to the shape of a user's torso, in order to provide additional conform to the user.

According to another aspect, the bulletproof vest may be configured to have a neck portion that wraps around a neck and a head portion that encases the user's head. It is noted that the head portion may be further configured to have openings near the user's eyes, nose, mouth, and ears. Furthermore, the neck portion and head portion may be permanently attached (or detachable) to the bulletproof vest.

According to another embodiment, the bulletproof vest can be made from a combination of two materials, one of them from aramid (which has high performance fibers and yarns, and used as ballistic protection), and another material from Ultra-high-molecular-weight polyethylene (UHMWPE). UHMWPE (e.g., Spectra® and Dyneema®) has low density, high tensile and compressive strength, high modulus, high rupture strain, resistance to thermal degradation and high-energy absorption capacity. Such materials may be in a variety of forms, such as, in sheets, films, and molded objects. Details relating to the aramid and UHMWPE are discussed later.

It is noted that the configuration and materials used for ballistic resistance are not limited to a bulletproof vest but may be used in various types of armor. For example, the ballistic resistant material/fabric may be used as an insert in conjunction with other clothing garments, or may be used in helmets, gloves, face masks or the like, so as to protect vital parts and organs of the wearer. Furthermore, the ballistic resistant material may be used in structural components of helicopters and other military equipment.

According an aspect of another embodiment, the ballistic armor fabric of aramid and UHMWPE may also be treated/produced with nanotechnology to obtain a material for bulletproof vests, due to its combination of high elastic modulus, high yield strain, high strength and high strain at tensile failure. For example, the fabric may be fabricated with carbon nanotubes (CNTs), graphites, and graphene oxides or the like. It is noted that while nanotechnology may be used to improve ballistic resistance, other various nanoparticles may also be used to improve other aspects of the fabric such as providing ultraviolet light (UV) protection, fire retardant protection, and radiation protection. For instance, one or more of the following nano-sized particles/materials, such as, cerium oxide, aluminum, copper, tungsten, barium, boron, bismuth, tantalum, silver, gold, platinum, depleted uranium, yttrium oxide, lanthanum oxide, and neodymium oxide, may be used to coat the individual fibers of the aramid and UHMWPE fabric, or may be added into the polymer matrix.

As discussed above, the treatment of ballistic materials with nanotechnology can improve protection against blunt trauma effects, and can also improve impact puncture and penetration resistance, which provide the wearer of the vest enhanced protection against blunt trauma effects.

### BALLISTIC MATERIALS

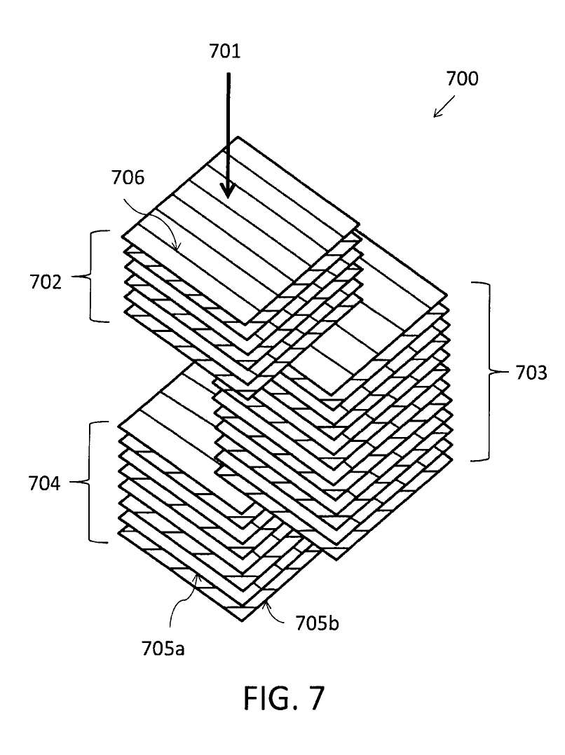

According an aspect of another embodiment, the body armor can include materials such as unidirectional (UD) aramid, UHMWPE, and woven aramid (e.g., argus aramid) in sheet shape or the like. As illustrated in FIG. 7, the UD aramid may have a configuration such that the fibers (e.g., 706) on one layer all extend in the same direction. Furthermore, the fibers (such as Kevlar® 29, 49, 129 and 149 aramid fibers) may have properties ranging from 1,100 to 1,500 denier, preferably 1,200 to 1400 denier, and more preferably 1,250 to 1,300 denier. The fibers may also have density ranging from 0.05 lb/in³ to 0.06 lb/in³, preferably from 0.05 lb/in³ to 0.055 lb/in³, and more preferably from 0.051 lb/in³ to 0.053 lb/in³. The fibers may also have a moisture level ranging from 2% to 10%, preferably from 3.0% to 8%, and more preferably from 3.5 to 7.0%. The fibers may further have a breaking strength ranging from 50 lbs to 100 lbs, preferably from 55 lbs to 80 lbs, and more preferably from 59 to 76 lbs. The fibers may have breaking tenacity ranging from 15 g/d to 40 g/d, preferably from 15 g/d to 25 g/d, and more preferably from 20 g/d to 23 g/d. The fibers may have tensile modulus ranging from 500 g/d to 1000 g/d, preferably from 525 g/d to 900 g/d, and more preferably from 555 g/d to 885 g/d. Moreover, the fibers may have elongation at break ranging from 2.0% to 5.0%, preferably from 2.2% to 4.0%, and more preferably from 2.4% to 3.6%. The fibers may each have a filament diameter ranging from 10 to 14 microns, preferably 11-13 microns, and more preferably 12 microns.

As for the UD aramid fabric, it may be treated with nanotechnology to offer enhanced bullet stopping power and reduced back face deformation even in hot climates and environments. Furthermore, the UD aramid fabric may also have a configuration to help absorb the energy of the bullet by having fibers on one layer extend in a diagonal orientation/direction with respect to the fibers of adjacent layers.

As for the UHMWPE material, it is made of super high tenacity and high modulus PE fiber, so it has various characteristics such as being soft, light, corrosion resistant, impact absorption, and moisture-proof. The UHMWPE material has extremely long chains and has a molecular mass ranging between 2 to 6 million u. The highest tenacity and lowest density materials for bulletproof UD fabric can promptly distribute energy of bullet on a large area so as to reduce depth of concavity of bulletproof materials so that non-penetration injury can be therefore reduced due to high strain. According to one example, the polyethylene can be treated with nanocomposite material to manufacture the UHMWPE. This treatment with nanocomposite (e.g., polyolefin nanocomposite comprising 40% to 50% of nanosized layered clay particles, preferably 42% to 46% of nanosized layered clay particles, and more preferably 45% of nanosized layered clay particles) may improve ballistic properties for polyethylene and is reflected in significant reduction in the projectile velocity as determined by ballistic test. Additionally, the fabric can absorb a shock from the bullet and block smashed bullet pieces to prevent secondary injury to the wearer. The UHMWPE fiber, such as Spectra° fiber 1000, may have characteristics ranging from 200 to 2600 denier, preferably from 500 to 2000 denier, and more preferably from 1000 to 1400 denier. The UHMWPE fibers may further have tensile strength ranging from 2.0 Gpa to 4.0 Gpa, preferably from 2.5 Gpa to 3.6 Gpa, and more preferably from 2.6 Gpa to 2.8 Gpa. The UHMWPE fibers may also have breaking strength ranging from 10 lbs to 100 lbs, preferably from 24 lbs to 80 lbs, and more preferably from 44 lbs to 60 lbs. The UHMWPE fibers may further have an E-modulus ranging from 80 to 130, preferably 90 to 120, and more preferably from 98 to 113. The UHMWPE fibers may also have elongation ranging from 2.0 to 5.0%, preferably from 2.4 to 4.4%, and more preferably from 2.9 to 3.5%. The UHMWPE fibers may also have density ranging from 0.02 lbs/in³ to 0.05 lbs/in³, preferably from 0.025 lbs/in³ to 0.04 lbs/in³, and more preferably from 0.034 lbs/in³ to 0.036 lbs/in³. The UHMWPE may also have specific gravity as low as 0.97. Each of the fibers may have a diameter ranging from 10 μm to 20 μm, preferably 12 μm to 18 μm, and more preferably 17 μm.

As for the aramid sheet, it is unaffected by moisture, humidity or perspiration, because it is waterproof. The aramid sheet can be a fabric woven of plain weave 1/1, the warp and weft count ranging from 600 to 1000 denier, preferably 700 to 900 denier, and more preferably 800 denier. It may be encapsulated in a thermoplastic coated proprietary resin. It may also be impregnated with 10% to 20% by weight of Polyvinyl Butyral (PVB)-phenolic resin, preferably 15% to 18% by weight of PVB-phenolic resin, and more preferably 16% by weight of PVB-phenolic resin, for example. This fabric can be designed to stop penetration and absorb the impact and disperse the energy transmitted by the bullet. In addition, the ballistic armor fabric of aramid sheet can be treated also with nanotechnology to obtain a material for bulletproof vests due to its unique combination of exceptionally high elastic modulus, high yield strain, and high strength failure. The aramid sheet may also be argus aramid fabric with UD fibers. As discussed above, the UD fibers may have a configuration such that fibers on one layer all extend along one direction and fibers on adjacent layers extend in another direction.

ARRANGEMENT OF LAYERS

According an aspect of an embodiment, the arrangement of the layers of the ballistic material improves protection by placing each type of raw materials in the suitable position depending on mechanical properties. The various embodiments with respect to the arrangement of the layers are discussed later. Each of the different layers may be combined together by various stitching and sewing methods such as lock stitching, chain stitching, zig-zag stitching or the like.

MECHANICAL PROPERTIES OF THE BALLISTIC MATERIALS

Mechanical properties of ballistic materials describe the behavior of material in terms of deformation and resistance to deformation under specific mechanical loading conditions. These properties are significant as they describe the load state of material under stress. Elastic modulus, work of rupture and strain are some of the common mechanical properties of ballistic materials.

All results of mechanical testing was used depending on its advantages to choose various arrangements of the materials as strike face and wear face, when implementing the design of experiments to predict the performance of body armor prior of shooting.

BREAKING STRENGTH TEST

The breaking strength of ballistic textile material may be measured by applying a tensile force parallel to the plane of the textile material and great enough to induce failure or rupture. By testing the breaking strength, it is possible to compare different materials to their inherent strength.

Test standard ASTM D 5035 was applied for breaking strength.

All tests were carried out in standard laboratory.

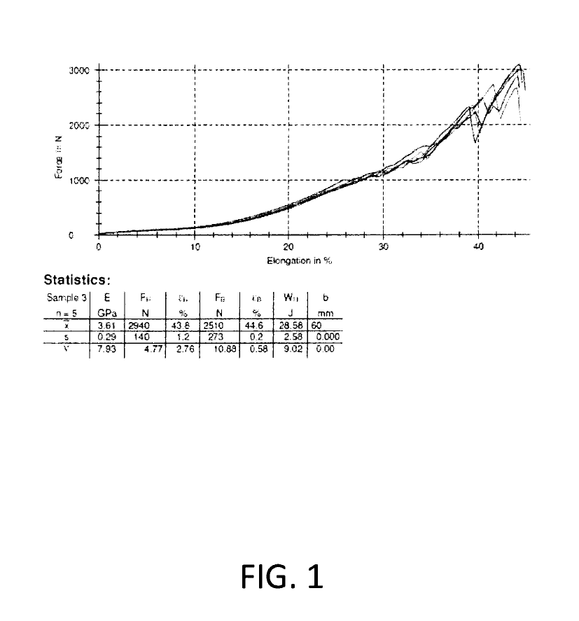

FIG. 1 shows the breaking strength of UD aramid is approximately 251 kg and the strain at break is approximately 44.6%.

WORK OF RUPTURE AND ENERGY ABSORPTION OF UD ARAMID

During breaking strength, the tensile force applied to the ballistic of textile material is steadily increased, at the same time, the textile material elongates under the influence of this tensile force.

It is clear that work is being done on the specimen. The work done up to the instant of tensile failure is called the “work to rupture.” It is the area under the curve as shown in FIG. 1 and corresponds to a value of approximately 28.58 Joule for UD aramid.

Energy absorption=work of rupture/area of sample.

Because all samples may have the same area and the energy absorption is directly proportional to work of rupture, the ballistic material, which has high work of rupture, will have also high energy absorption. Thus, it may be placed at the first group of layers as the strike face.

By comparing work of rupture for the three materials, it may be found that the work of rupture of UD aramid achieved the maximum work of rupture. In other words, high energy absorption may help to absorb the sudden shock of bullet, and return back flexibility. Thus, the UD aramid may be arranged in the front of body armor, because the UD aramid material will return back flexibility once the bullet strikes the UD aramid material.

Thus, in one example of an embodiment, the UD aramid is disposed in the first group of layers of ballistic materials.

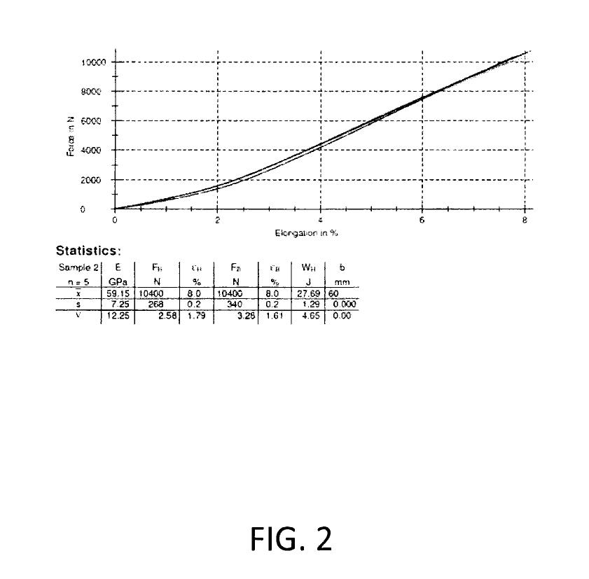

FIG. 2 illustrates that the breaking strength of UHMWPE is approximately 1040 kg and that the strain at break is approximately 8%.

WORK OF RUPTURE AND ENERGY ABSORPTION OF UHWMPE

As illustrated in FIG. 2, the work of rupture for the ballistic material of UHMWPE is approximately 27.69 Joule.

By comparing the work of rupture for the three materials, it was found that the work of rupture of UHMWPE is below the work of rupture of UD aramid. However, the data showed that UHMWPE also can absorb the energy of bullet.

Thus, in one embodiment, the UHMWPE material may be arranged in the second group of layers of body armor.

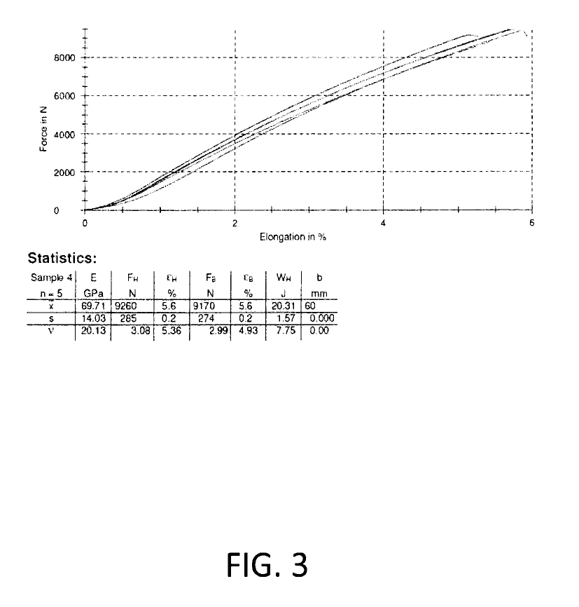

FIG. 3 illustrates the breaking strength of aramid sheet is approximately 917 kg and the strain at break is approximately 5.6%.

WORK OF RUPTURE AND ENERGY ABSORPTION OF ARAMID SHEET

The work of rupture for this ballistic material of aramid sheet is approximately 20.31 Joule.

By comparing work of rupture for the three materials, it was found that work of rupture of aramid sheet is below the work of rupture of UD aramid and UMIIWPE. In other words, the aramid sheet can be arranged in the third group of layers of body armor, so as to stop the bullet and reduce the blunt.

The aramid sheet can be arranged as the wear face of body armor (i.e. the layer that is close to the wearer), because the aramid sheet may not have the ability to absorb sudden shock energy of bullet, but has the ability to stop a bullet after reduction the energy of bullet through previous layers of ballistic material and to reduce the blunt.

From the analysis of the strain and work of rupture of the three ballistic materials, the material can be arranged depending on work of rupture to get high performance for the body armor during end use.

To confirm that the mechanical properties of ballistic can predict the performance and arrangement of body armor, E-modulus is discussed to evaluate the ballistic materials.

E-Modulus (Young's Modulus)

Young's modulus measures the resistance of a material to elastic deformation under load. A stiff material has a high Young's modulus and changes its shape only slightly under elastic loads. On the other hand, a flexible material has a low Young's modulus and changes its shape considerably. From the results of the three ballistic materials, as shown in FIGS. 1-3, it was found that E-modulus of UD aramid is approximately 3.61 GPa, E-modulus of UHMWPE is approximately 59.15 GPa, and E-modulus of aramid sheet is approximately 69.71 GPa.

From these results, the UD aramid may be arranged as the strike face and the aramid sheet may be arranged as wear face, while the UHMWPE material may be disposed in between the UD aramid and the aramid sheet, according to one example.

TEST OF BURSTING STRENGTH

The bursting strength is a function of both tensile strength and stretch. The choice of the raw materials is not based on the famous trade name of raw materials in the market, but based on the mechanical properties that achieve high efficiency and for body armor during end use. A test was used as a simulation to evaluate the ballistic materials so as to predict the behavior and quality during shooting.

There are two possibilities during the shooting of the body armor. A first possibility is that the bullet penetrates all layers of body armor. In other words, the armor failed in repelling the bullet. In this case, the armor was not suitable for end use as protection. A second possibility is that the bullet penetrates some layers and returns back with the rest of the layers in a distance not exceeding a blunt trauma of 44 mm according to NIJ level IIIA. Thus, in this case, the armor may be suitable for end use.

The test of bursting will simulate the required force could be borne by a single layer of material till bursting and also the maximum distance of ball penetration inside the material. The test result of bursting may help to compare and evaluate the material to choose regarding the arrangement and the number of layers.

In one embodiment, the test standard ASTM D 3787 was applied for bursting strength. All tests were carried out in standard laboratory.

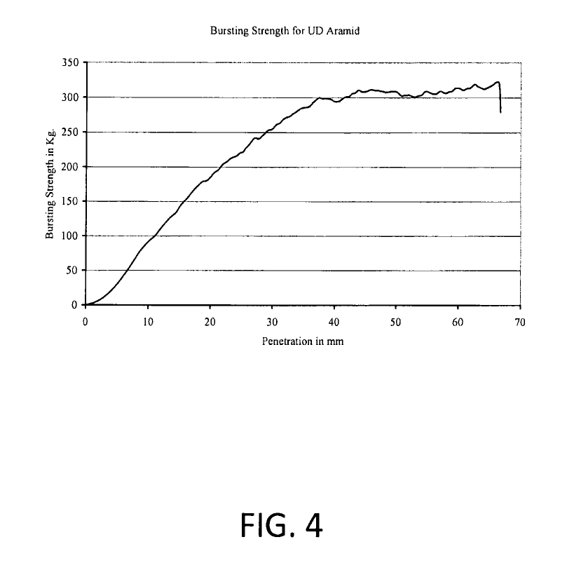

FIG. 4 shows that bursting strength of UD aramid fabric is approximately 322 kg and the penetration within this material is about 66 mm. In other words, the material may have the ability to absorb the sudden shock from the bullet, and penetrate back certain distance to stop the bullet, so this material can be arranged as first layers.

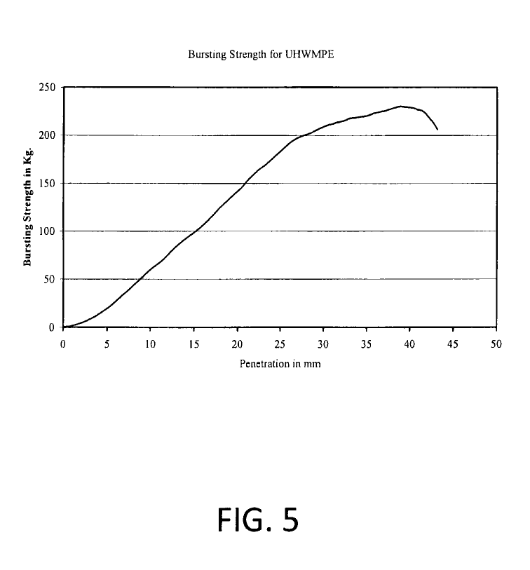

FIG. 5 illustrates that the bursting strength of UHMWPE is approximately 229 kg, and the penetration within this material is about 45 mm. In other words, the material may have the ability to absorb the sudden shock from the bullet, and penetrate back certain distance to stop the bullet, but its flexibility is ranked below UD aramid. Thus, UHMWPE can be arranged as second layers of body armor.

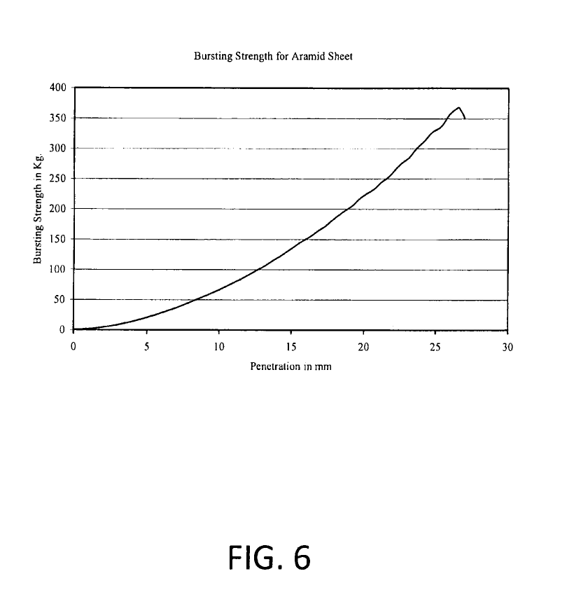

FIG. 6 illustrates that the bursting strength of aramid sheet is approximately 360 kg, and the penetration within this material is about 27 mm. In other words, the material is likely very stiff and is likely to be penetrated very easily when arranged as a first layer. However, the aramid sheet material has the ability to stop the bullet after recharge its energy through absorption from the two other layers, so aramid sheet may be arranged as third layers of body armor in order to reduce the blunt trauma.

From mechanical properties of breaking and bursting strength, the ballistic materials can be arranged by selected UD aramid at the front of body armor (because of its mechanical properties which help absorb shock), followed by layers of UHMWPE to absorb the rest of shock and to reduce the blunt into the body, and layers of aramid sheet arranged as the wear face.

NUMBER OF LAYERS FOR BALLISTIC MATERIAL

There is a relation between the numbers of layers for bulletproof vest and its weight, the relation being such that as the layers increase, the weight also increases. Thus, it is important to have a bullet proof vest which is lightweight and achieves the necessary level of protection.

At least twenty seven experiments were conducted in order to determine configurations regarding the number of layers for ballistic materials, weight of body armor, and minimum blunt trauma. At least twenty seven panels were prepared with three levels of numbers of layers for UD aramid, UHMWPE, and aramid sheet. The various panels were prepared with different combinations of the three ballistic materials and arrangements.

APPLICATION OF SHOOTING TEST

The required materials for the experiments were cut, prepared and insert into a cordura fabric with the same arrangement and number of layers for every experiment. In one example, the test of shooting was carried on the various panels in a shooting field, with all required equipment for Standard-0101.04 NIJ standard: type of handgun bullets—MP5, bullet diameter—9 mm, bullet mass—8 gram, speed of bullet—427 m/s, and distance of shooting—5 meters.

From the experimental data of the various panels, it was found that none of the panels were penetrated by the bullet. There was only deformation which varied from panel to other, which depended on the predicted arrangement of plies of ballistic materials and number of plies. The performance of armor is judged by how well it stops bullets from penetrating its defenses and the amount of “backface signature” or blunt force trauma. Minimizing blunt trauma is also very important for protecting wearers against damages to internal organs and broken bones. The experimental data of shooting also shows that the blunt trauma varied from 14.8 mm (as minimum) and 24 mm (as maximum). Furthermore, the experimental data showed that while all the panels may have different weight, all of them satisfied the requirements of protection level of NIJ standard-0101.04.

Thus, according to one embodiment, a bullet proof vest may be 2.9 kg and may have a blunt trauma of 17 mm.

ARRANGEMENT OF LEVELS AND LAYERS OF FABRICS

FIG. 7 shows an arrangement of different levels and layers of fabric for an article 700 that may be used as a ballistic resistant vest or the like.

As shown in FIG. 7, the article 700 may have a plurality of levels of fabric 702, 703, 704 that may be disposed in a stacking manner. Each of the plurality of levels of fabric 702, 703, 704 may further include a plurality of layers 705a, 705b. As illustrated in FIG. 7, one of the plurality of layers (e.g., 705a) may have fibers 706 that extend along a first direction, and another one of the plurality of layers (e.g., 705b) may have fibers 706 that extend along a second direction that is different from the first direction. The second direction may be substantially diagonal to the first direction, or may be at any inclined angle with respect to the first direction. As illustrated in FIG. 7, each of the fibers 706 that are disposed on the same layer extends parallel to each other.

According to an example, the plurality of layers (e.g., 705a, 705b) are arranged such that adjacent layers do not have fibers 706 extending in a same direction, and/or are arranged in an alternating manner.

According to one example, the first level of fabric 702 may include UD aramid, or the like, the second level of fabric 703 may include UHMWPE, or the like, and the third level of fabric 704 may include woven aramid, or the like.

According to another example, the first level of fabric 702 may include at least six layers of the UD aramid, the second level of fabric 703 may include at least twelve layers of the UHMWPE, and the third level of fabric 704 may include at least eight layers of the woven aramid. However, the number of layers may be adjusted and varied.

According to another example, the first level of fabric 702 may be configured to absorb sudden energy of a projectile, the second level of fabric 703 may be configured to distribute and absorb energy of a projectile, and the third level of fabric 704 may be configured to stop a projectile and to reduce blunt trauma.

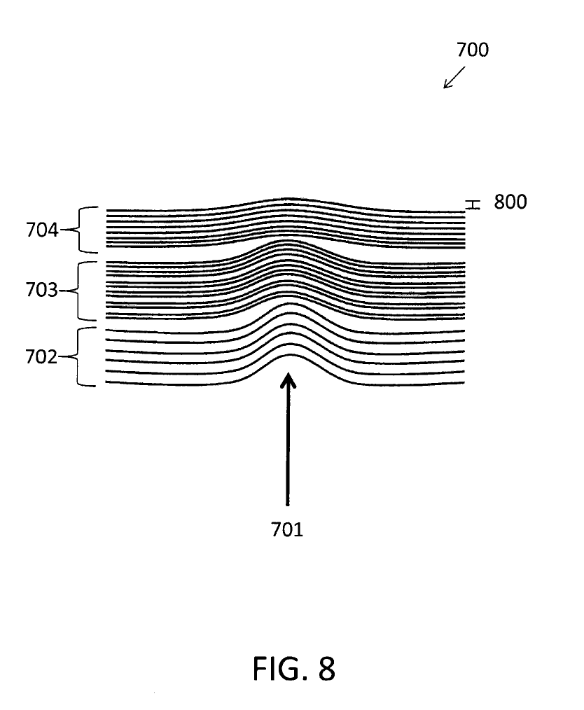

FIG. 8 shows a cross-sectional view of the article 700. In particular, FIG. 8 illustrates that a force 701 from, for example, a bullet or the like, striking the first level of fabric 702. FIG. 8 illustrates how the plurality of levels of fabric 702, 703, 704 absorbs and distributes the energy from the force throughout the fabric.

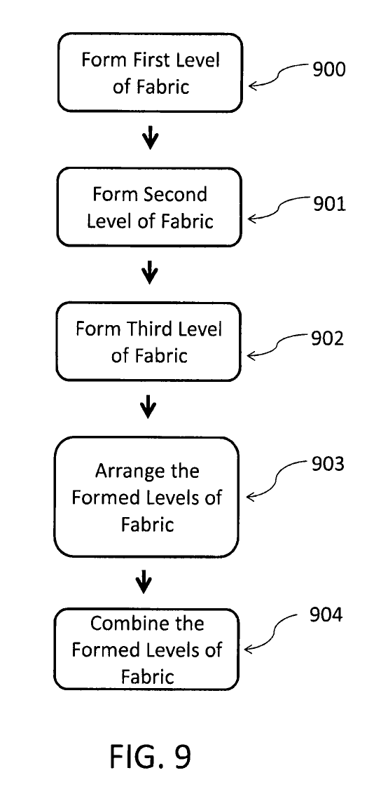

FIG. 9 illustrates a flowchart for a method according an aspect of one embodiment. Referring to Steps 900-902, the first level of fabric 702, the second level of fabric 703, and the third level of fabric 704 are formed, respectively. Furthermore, referring to Steps 903 and 904, the first level of fabric 702, the second level of fabric 703, and the third level of fabric 704 are arranged and combined in a manner to manufacture the article 700 as depicted in FIGS. 7 and 8. It is noted that certain details have been left out of the flowchart that may be apparent to one of ordinary skill in the art. For example, a step may include one or more sub-steps or may involve specialized materials, as known in the art.

Accordingly, in one embodiment, a bulletproof vest (based on the ballistic materials and arrangements discussed above) has a weight ranging from 2.0 kg to 4.0 kg, preferably from 2.5 kg to 3.5 kg, and more preferably from 2.8 kg to 3.0 kg, and a blunt trauma ranging from 15 mm to 20 mm, and preferably from 16.5 mm to 18.5 mm, and more preferably from 16.5 mm to 17.5 mm.

The above disclosure also encompasses the embodiments listed below.

(1) An article including: a first level of fabric; a second level of fabric; and a third level of fabric, wherein: the first level of fabric includes unidirectional (UD) aramid and the second level of fabric includes ultra-high-molecular-weight polyethylene (UHMWPE); the second level of fabric is disposed in between the first level of fabric and the third level of fabric; and at least one of the levels of fabric includes a plurality of layers, the plurality of layers being arranged such that fibers of one layer extend along a first direction and fibers of another layer extend along a second direction that is substantially diagonal to the first direction.

(2) The article according to (1), wherein the third level of fabric includes woven aramid.

(3) The article according to (1) or (2), wherein the first level of fabric includes at least six layers of the UD aramid.

(4) The article according to any one of (1) to (3), wherein the second level of fabric includes at least twelve layers of the UHMWPE.

(5) The article according to any one of (1) to (4), wherein the third level of fabric includes at least eight layers of the woven aramid.

(6) The article according to any one of (1) to (5), wherein the first level of fabric includes only six layers of the UD aramid.

(7) The article according to any one of (1) to (6), wherein the second level of fabric includes only twelve layers of the UHMWPE.

(8) The article according to any one of (1) to (7), wherein the third level of fabric includes only eight layers of the woven aramid.

(9) The article according to any one of (1) to (8), wherein the plurality of layers are arranged such that adjacent layers do not have fibers extending in a same direction.

(10) The article according to any one of (1) to (9), wherein the plurality of layers are arranged such that adjacent layers do not have fibers extending in a same direction.

(11) The article according to any one of (1) to (10), wherein the plurality of layers are arranged such that adjacent layers do not have fibers extending in a same direction.

(12) The article according to any one of (1) to (11), wherein the third level of fabric includes woven aramid.

(13) The article according to any one of (1) to (12), wherein the third level of fabric includes woven aramid.

(14) The article according to any one of (1) to (13), wherein a reduction of blunt trauma is 17 mm.

(15) The article according to any one of (1) to (14), wherein the plurality of layers are arranged in an alternating manner.

(16) The article according to any one of (1) to (15), wherein the plurality of layers are arranged in an alternating manner.

(17) The article according to any one of (1) to (16), wherein the first level of fabric is configured as a strike face with respect to a ballistic object.

(18) The article according to any one of (1) to (17), wherein a combination of the first level of fabric, the second level of fabric, and the third level of fabric has a maximum weight of approximately 2.9 kg according to NIJ Standard 0101.04.

(19) The article according to any one of (1) to (18), wherein the third level of fabric is configured to be closest to a user among the levels of fabric, when the user wears the article.

(20) A method of manufacturing the article according to any one of (1) to (19), the method comprising: forming a first level of fabric; forming a second level of fabric; forming a third level of fabric; arranging the second level of fabric in between the first level of fabric and the third level of fabric; and combining the first level of fabric, the second level of fabric, and the third level of fabric.

Obviously, numerous modifications and variations of the present invention are possible in light of the above teachings. It is therefore to be understood that within the scope of the appended claims, the invention may be practiced otherwise than as specifically described herein.

1. An article comprising:
a first level of fabric;
a second level of fabric; and
a third level of fabric, wherein:
the first level of fabric includes unidirectional (UD) aramid and the second level of fabric includes ultra-high-molecular-weight polyethylene (UHMWPE);
the second level of fabric is disposed in between the first level of fabric and the third level of fabric; and
at least one of the levels of fabric includes a plurality of layers, the plurality of layers being arranged such that fibers of one layer extend along a first direction and fibers of another layer extend along a second direction that is substantially diagonal to the first direction.

2. The article according to claim 1, wherein the third level of fabric includes woven aramid.

3. The article according to claim 1, wherein the first level of fabric includes at least six layers of the UD aramid.

4. The article according to claim 1, wherein the second level of fabric includes at least twelve layers of the UHMWPE.

5. The article according to claim 2, wherein the third level of fabric includes at least eight layers of the woven aramid.

6. The article according to claim 1, wherein the first level of fabric includes only six layers of the UD aramid.

7. The article according to claim 1, wherein the second level of fabric includes only twelve layers of the UHMWPE.

8. The article according to claim 2, wherein the third level of fabric includes only eight layers of the woven aramid.

9. The article according to claim 1, wherein the plurality of layers are arranged such that adjacent layers do not have fibers extending in a same direction.

10. The article according to claim 2, wherein the plurality of layers are arranged such that adjacent layers do not have fibers extending in a same direction.

11. The article according to claim 3, wherein the plurality of layers are arranged such that adjacent layers do not have fibers extending in a same direction.

12. The article according to claim 3, wherein the third level of fabric includes woven aramid.

13. The article according to claim 4, wherein the third level of fabric includes woven aramid.

14. The article according to claim 1, wherein a reduction of blunt trauma is 17 mm.

15. The article according to claim 1, wherein the plurality of layers are arranged in an alternating manner.

16. The article according to claim 2, wherein the plurality of layers are arranged in an alternating manner.

17. The article according to claim 1, wherein the first level of fabric is configured as a strike face with respect to a ballistic object.

18. The article according to claim 1, wherein a combination of the first level of fabric, the second level of fabric, and the third level of fabric has a maximum weight of approximately 2.9 kg according to NIJ Standard 0101.04.

19. The article according to claim 1, wherein the third level of fabric is configured to be closest to a user among the levels of fabric, when the user wears the article.

20. A method of manufacturing the article according to claim 1, the method comprising:
forming a first level of fabric;
forming a second level of fabric;
forming a third level of fabric;
arranging the second level of fabric in between the first level of fabric and the third level of fabric; and
combining the first level of fabric, the second level of fabric, and the third level of fabric.
